(19) United States
(12) Patent Application Publication
(10) Pub. No.: US 2013/0048550 A1
(43) Pub. Date: Feb. 28, 2013

(54) WATER TREATMENT SYSTEM WITH SEALING ENCLOSURE

(71) Applicants: Michael E. Miles, Grand Rapids, MI (US); Karen J. VanderKooi, Grand Rapids, MI (US); Terry L. Lautzenheiser, Nunica, MI (US); Karlis Vecziedins, Caledonia, MI (US)

(72) Inventors: Michael E. Miles, Grand Rapids, MI (US); Karen J. VanderKooi, Grand Rapids, MI (US); Terry L. Lautzenheiser, Nunica, MI (US); Karlis Vecziedins, Caledonia, MI (US)

(73) Assignee: ACCESS BUSINESS GROUP INTERNATIONAL LLC, Ada, MI (US)

(21) Appl. No.: 13/214,659

(22) Filed: Aug. 22, 2011

(51) Int. Cl. B01D 35/30

(52) U.S. Cl. 210/251

(57) ABSTRACT

A water treatment system having a sealing enclosure for separating an electronics module from a water treatment assembly within the housing of the water treatment system. The sealing enclosure is a one-piece component having a perimeter seal that extends continuously around the periphery of the sealing enclosure. The perimeter seal is configured to directly engage the housing to automatically create a seal as the sealing enclosure is installed in the housing. The sealing enclosure includes a stationary portion and a movable portion joined along a living hinge. The movable portion covers an accessible compartment and can be selectively swung open about the living hinge to provide access to the interior of the accessible compartment, for example, to replace the batteries. The movable portion can be closed to reengage the housing and reestablish the seal. The electronics module may include an electronic components mounting bracket. The sealing enclosure may be mounted to the bracket. The sealing enclosure may be configured to interfit with support features in the bracket.

### BACKGROUND OF THE INVENTION

The present invention relates to water treatment systems and more specifically to housings and sealing enclosures for water treatment systems.

Conventional residential water treatment systems are typically self-contained units that include a water treatment section and components for moving untreated water through the water treatment section for treatment. Generally, operation of the water treatment section is controlled by electronics. For example, the water treatment system often includes an electrically powered treatment device, such as a UV lamp. As a result, many water treatment systems include electronics and other electrical components. This may include a controller that is programmed to operate the water treatment system. In many applications, the water treatment system also includes a battery compartment to contain batteries that can be used to provide power to the system. In some cases, the batteries may be the primary source of power for the system. In other applications, the batteries may be a secondary power source to allow the water treatment system to operate when wall power is unable.

A water treatment system typically includes an outer housing that contains the electronics as well as the water treatment section and related components. The housing usually includes an assembly of various components that “permanently” contain certain components of the water treatment systems, such as the electronics, while allowing selective access to other components, such as consumables like filters, UV lamps and batteries. In some cases, the electronics are contained in a structure that is sealed with an o-ring or gasket. In other cases, the electronics may be contained within a compartment that is sealed shut by sonic welding or other similar methods. In systems that include batteries, the batteries are often contained in a separated compartment having an access door. A separate seal is often used to form a seal around the compartment door. For example, a gasket or o-ring may be fitted about the compartment door or about the surface engaged by the closed compartment door.

### SUMMARY OF THE INVENTION

The present invention provides a water treatment system with a housing that includes a sealing enclosure having an integrated seal and an access point, which articulate about a living hinge. In one embodiment, the sealing enclosure includes a peripheral edge that is shaped to define a perimeter seal that engages the housing to provide a continuous seal. In this embodiment, the sealing enclosure is manufacture from a material that can form a seal by virtue of an interference fit with the housing. In one embodiment, the peripheral edge of the sealing enclosure is shaped to provide a wiper-blade-type seal.

In one embodiment, the sealing enclosure includes a stationary portion that is fixedly secured to seal an electronics compartment and a movable portion that is selectively movable to gain access to a separate compartment without exposing the electronics in the sealed electronics compartment. The stationary portion and the movable portion may be joined by a living hinge. The accessible compartment may be a battery compartment, and the movable portion may function as the battery compartment door. The living hinge may extend along a chord from one location on the perimeter of the sealing enclosure to another.

The WTS may include an electronics module having an electronics assembly mounted to an electronics bracket. The sealing enclosure may be mounted to the electronics bracket. In one embodiment, the electronics bracket is mounted to the housing and the sealing enclosure is mounted to the electronics bracket such that the peripheral edge of the sealing enclosure is directly engaged with the housing around its entire perimeter.

In one embodiment, the sealing enclosure includes integral pull tabs that extend from the perimeter of the movable portion to provide a structure for opening the movable portion. The pull tabs may be extensions of the perimeter seal. Each pull tab may include a bump that helps to hold the pull tab away from the housing where it is easily gripped by a user. The pull tabs may interact with other structures to lock the movable portion in the closed position. For example, the pull tab may interlock with a protrusion or recess in the housing or the electronics module.

In one embodiment, the sealing enclosure is manufactured from a relatively soft material and is mounted to a relatively rigid electronics bracket that is configured to receive and support the sealing enclosure. The top housing and/or the electronics bracket may have fins that are interfitted with corresponding closed slots in the sealing enclosure. The fins may be arranged to provide adequate support for the sealing enclosure. The number and location of fins may vary from application to application based at least in part on the material properties of the sealing enclosure.

In an alternative embodiment, the sealing enclosure may include an overmolded construction. In this embodiment, the peripheral edge of the sealing enclosure may be formed from a different material than the rest of the sealing enclosure. The peripheral material may be softer than the other material to facilitate a leaktight seal with the surrounding structure. If desired, the living hinge may also be formed from the softer material to facilitate moving the movable portion relative to the stationary portion.

The present invention provides a simple and effective sealing enclosure that can be used in a WTS to seal an electronics compartment and a battery compartment. When the movable portion is closed, the stationary and movable portions cooperate to seal the electronics compartment and the battery compartment. When the movable portion is open, access to the battery compartment is provided while the stationary portion continues to prevent access to the electronics compartment. Manufacture of the sealing enclosure from a sufficiently soft material allows the peripheral edge of the sealing enclosure to seal directly against a surrounding structure, such as a portion of the WTS housing. In those embodiments that include a living hinge, manufacture is simplified and there is no need to add separate components to seal the hinge. When used, the integrated pull tabs facilitate selective opening and closing of the battery compartment door. When used, the electronics bracket allows the sealing enclosure to be manufactured from softer materials that facilitate a water resistant seal between the sealing enclosure and the housing.

These and other objects, advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a top, front perspective view of a sealing enclosure in accordance with an embodiment of the present invention.

FIG. 2 is a top, rear perspective view of the sealing enclosure.

FIG. 3 is a bottom, front perspective view of the sealing enclosure.

FIG. 4 is a partially exploded perspective view of a WTS incorporating the sealing enclosure.

FIG. 5 is an exploded top perspective view of the electronics module and the sealing enclosure.

FIG. 6 is an exploded bottom perspective view of the electronics module and the sealing enclosure.

FIG. 7 is a bottom perspective view of the sealing enclosure within the top housing.

FIG. 8 is a bottom perspective view of the sealing enclosure with the top housing with the movable portion open.

FIG. 9 is a sectional view showing the sealing enclosure within the upper housing without the electronic module.

FIG. 10 is a sectional view taken transversely across the water treatment system through the center of the water filter assembly.

FIG. 11 is a sectional view of an upper portion of the water treatment system taken from front to back through the water flow turbine.

FIG. 12 is a sectional view of an upper portion of the water treatment system taken transversely through the top housing screw bosses.

FIG. 13 is a sectional view of an upper portion of the water treatment system taken from front to back through an electronics bracket fin.

FIG. 14 is a perspective view of a sealing enclosure in accordance with an alternative embodiment.

### DESCRIPTION OF THE CURRENT EMBODIMENT

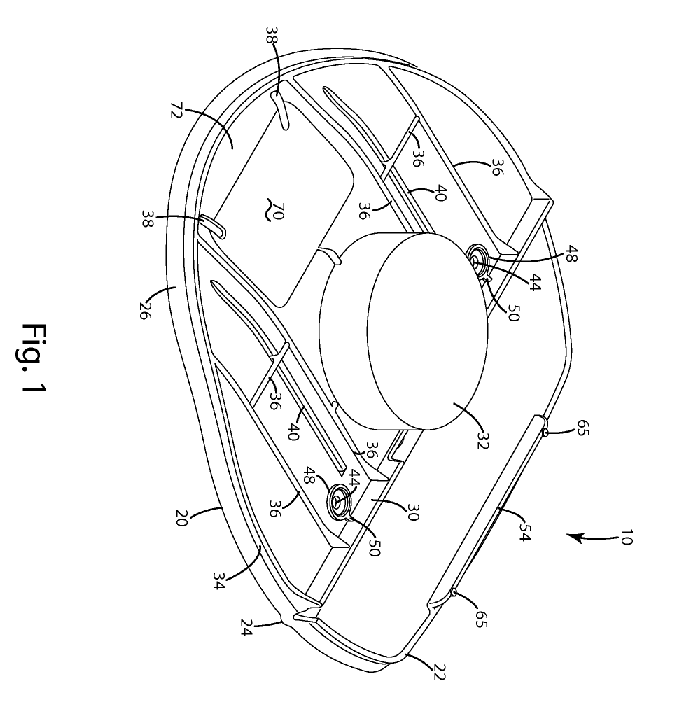

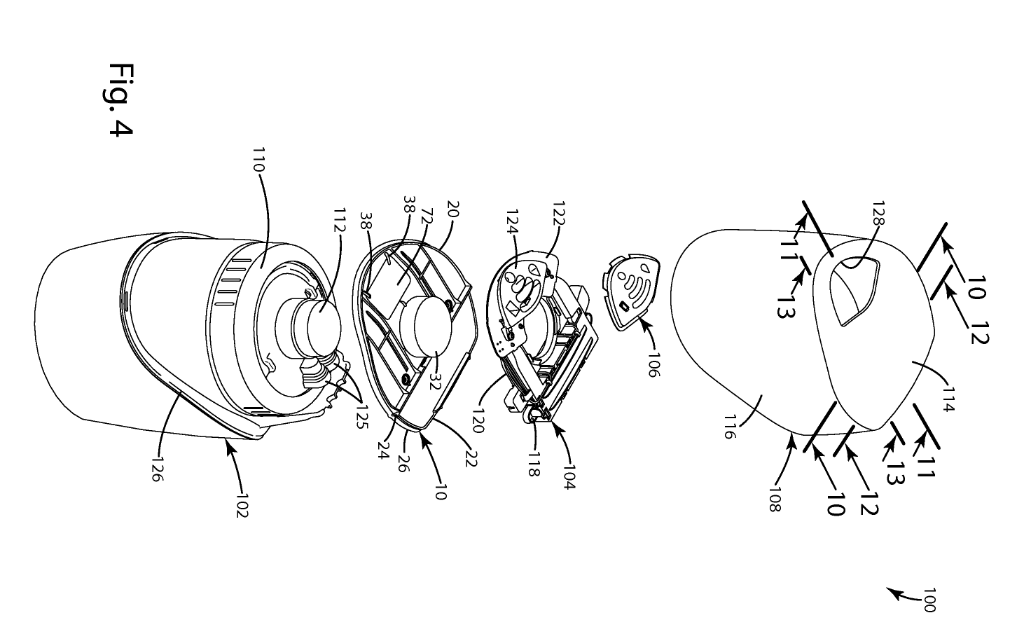

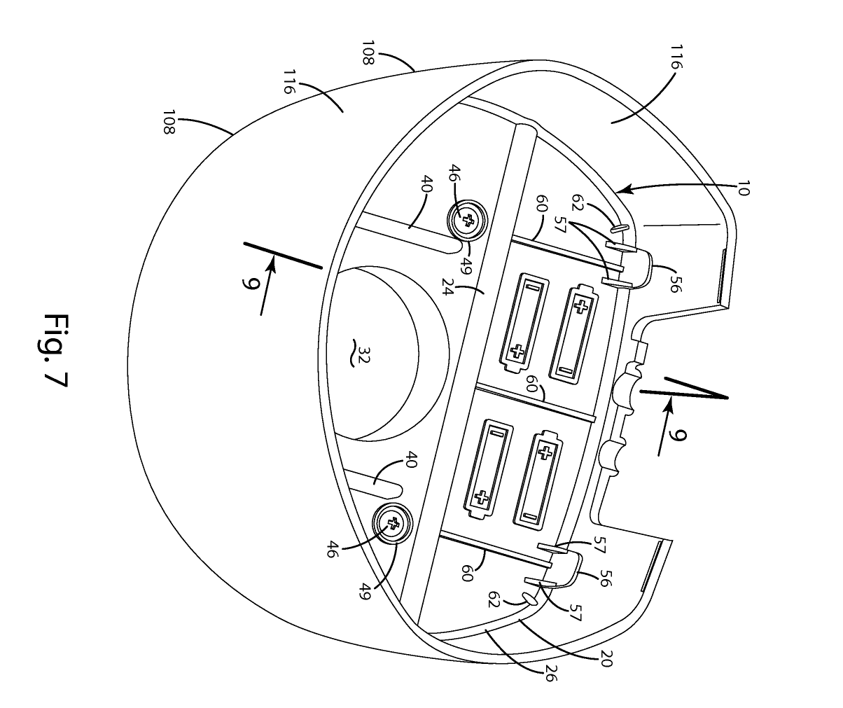

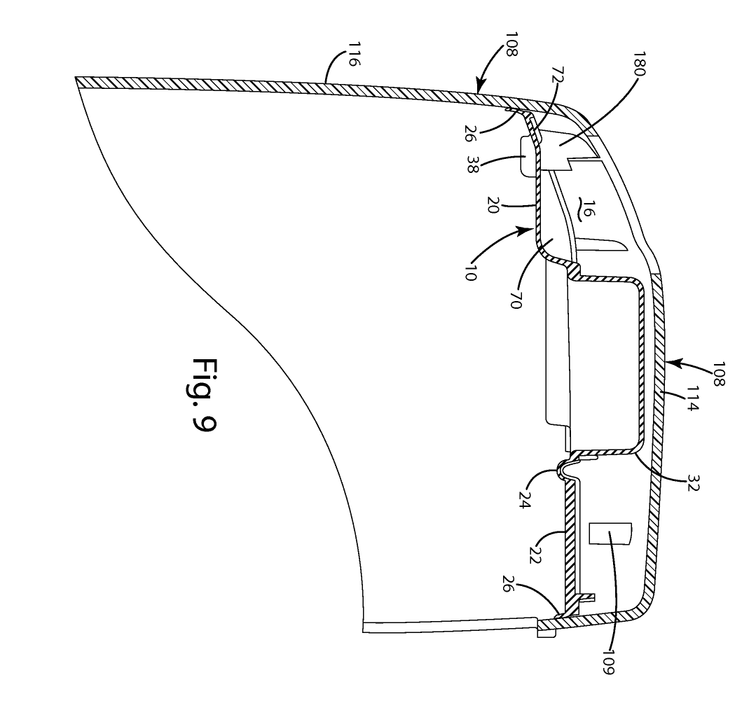

A sealing enclosure for a water treatment system (“WTS”) in accordance with an embodiment of the present invention is shown in FIG. 1. The sealing enclosure 10 of the illustrated embodiment is intended for use with a WTS 100 having an electronics module 104 mounted in a top housing 108 (See FIGS. 4 and 10). The electronics module 104 includes a battery compartment 132 (See FIG. 8). In this embodiment, the sealing enclosure 10 cooperates with the top housing 108 to provide a water resistant electronics compartment 16 while providing selective access to the battery compartment 132. The sealing enclosure 10 includes a stationary portion 20 that covers the electronics compartment 16 and a movable portion 22 that cover the battery compartment 132. The sealing enclosure 10 is a one-piece component in which the stationary portion 20 and the movable portion 22 are joined by a living hinge 24. The sealing enclosure 10 includes a perimeter seal 26 that directly engages the top housing 108 to provide a water resistant seal between the sealing enclosure 10 and the top housing 108. In this embodiment, the sealing enclosure 10 is manufactured from a relatively soft material that facilitates formation of a leaktight seal between the perimeter seal 26 of the sealing enclosure 10 and the top housing 108. In this embodiment, the electronics module 104 includes a rigid electronics bracket 120. The sealing enclosure 10 is mounted to the undersurface of the electronics bracket 120. The electronics bracket 120 provides structural support to the sealing enclosure 10 so that the sealing enclosure 10 may be manufactured from a softer material that more readily forms a seal with the top housing 108. During normal use, the movable portion 22 is closed so that the stationary portion 20 and the movable portion 22 cooperatively form a continuous seal with the surrounding top housing 108. The continuous seal protects the electronics compartment 16 and battery compartment 132 from water. When desired, the movable portion 22 may be manually swung open about the living hinge 24 to provide selective access to the batteries, for example, to replace spent batteries. After battery replacement, the movable portion 22 may be swung back into the closed position to reestablish a perimeter seal around the sealing enclosure 10 to protect the electronics module 104.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

For purposes of disclosure, the present invention is described in connection with a battery-operated WTS 100 in which the electronics are disposed in a top housing 108 that is fitted over the remainder of the WTS. The present invention is, however, well-suited and readily adapted for use with other types and styles of WTSs, including residential and commercial point-of-use WTSs. For example, the present invention may be used with WTSs that are capable of receiving power from other power sources, such as a wall outlet or other type of external source. Further, the present invention may be used with WTSs in which the electronics are located in alternative locations, such as in a bottom housing or a front housing.

As perhaps best shown in FIG. 4, the WTS 100 of the illustrated embodiment generally includes a bottom housing assembly 102, an electronics module 104, a display 106 and a top housing 108. The bottom housing assembly 102 is generally conventional and therefore will not be described in detail. Suffice it to say that, in this embodiment, the bottom housing assembly 102 includes the water treatment assembly 110, which may include a carbon filter (not shown) and the flow lines used to route water through the WTS 100. The WTS 100 may include additional or alternative water treatment devices, such as additional or alternative filters and disinfection devices, including without limitation UV lamps, dielectric barrier discharge lamps, chlorination devices, ozone devices, reverse osmosis devices, membrane filters and ceramic filters. As shown in FIGS. 4 and 10, the bottom housing assembly 102 may be shaped to receive and closely interfit with the top housing 108. For example, the outermost contours of the bottom housing assembly 102 may be configured to correspond with mating portions of the top housing 108. In the illustrated embodiment, the bottom housing assembly 102 includes a shoulder 126 configured to seat the top housing 108. The shoulder 126 extends around the periphery of the bottom housing assembly 102. Further, an upper cylinder 112 may extend from the top center of the bottom housing assembly 102. The upper cylinder 112 may be configured to correspond with a cylindrical recess 32 in the undersurface of the sealing enclosure 10.

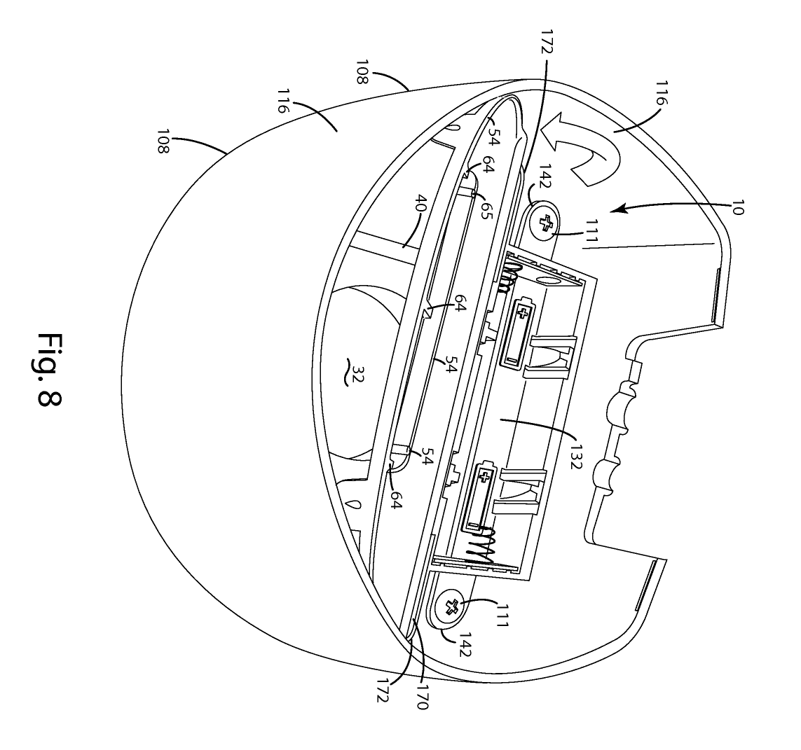

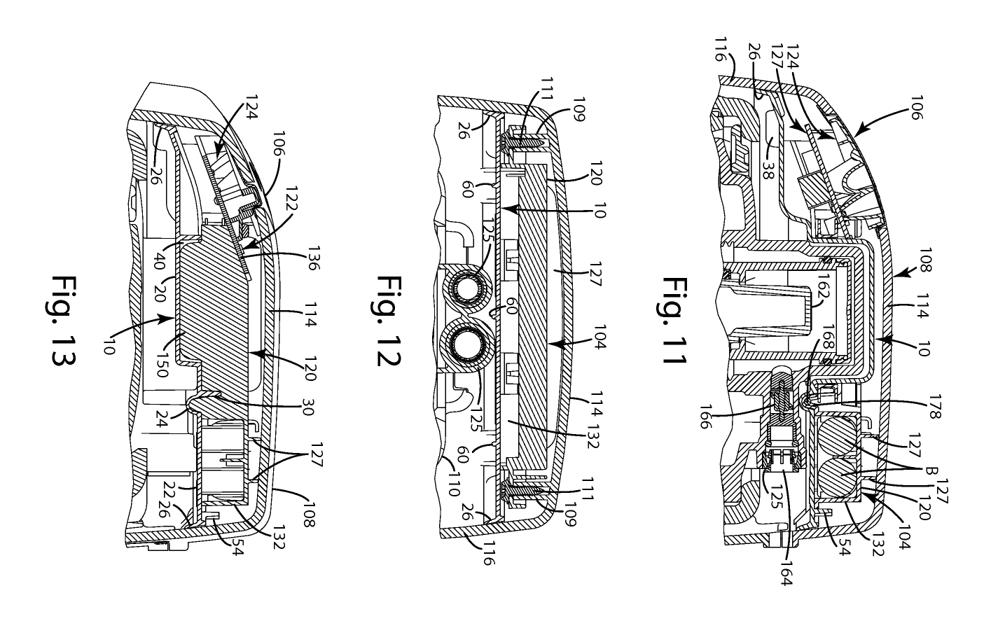

In the illustrated embodiment, the top housing 108 is somewhat bowl-shaped having a top wall 114 and a skirt 116 with an interior configured to receive the electronics module 104, the display 106 and the sealing enclosure 10. The skirt 116 may be shaped to interfit with the bottom housing assembly 102. More specifically, the skirt 116 may fit over the upper portion of the bottom housing assembly 102 and its bottom edge may be received by shoulder 126 surrounding the bottom housing assembly 102. The top housing 108 may include screw bosses 109 (See FIGS. 9 and 12) for securing the electronics assembly 104. The screw bosses 109 are located to receive screws 111 extending through screw holes 118 in the electronics bracket 120 (described below). The top housing 108 of this embodiment defines a display opening 128. The display opening 128 is configured to receive the display 106. In this embodiment, the display 106 is fitted into the display opening 128 from underneath. The top housing 108 of this embodiment also includes a pair of top housing fins 180 (See FIG. 9) that extend downwardly to be fitted into corresponding slots 38 in the sealing enclosure 10 (described in more detail below). The number, size, shape and configuration of the top housing fins 180 may vary from application to application, as desired.

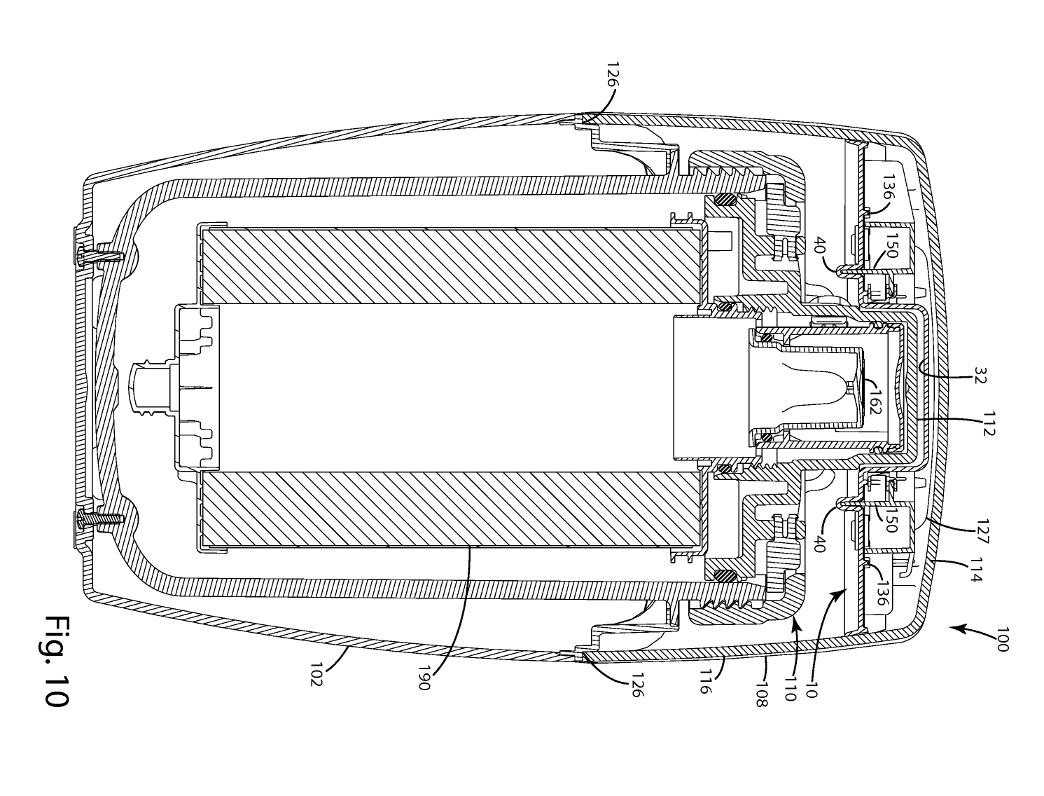

The electronics module 104 is mounted in the top housing 108 and provides monitoring and output. The display 106 may be configured to function as a user interface for the WTS 100. The purpose and function of the electronics module 104 and display 106 may vary from application to application. However, in the illustrated embodiment, the electronics module 104 performs a relatively limited set of functions. For example, the electronics module 104 may track the volume of water moved through the system, as well as the life of the carbon filter. The electronics module 104 may also provide information via the display 106, such as an indication of flow rate and filter life. In other applications, the electronics module 104 may provide additional features and functions. The WTS of this embodiment includes a mechanism for monitoring the volume of water flowing through the system. This allows the WTS to, among other things, track filter life and provide an indication via the display 106 when filter replacement is necessary or desirable. In this embodiment, the bottom housing assembly 102 includes a water flow turbine 166 that rotates in response to the flow of water through the system 100 and the electronics module 104 includes a sensor 168 that responds to movement of the turbine 166 (See FIG. 11). The turbine 166 may be mounted in a water inlet or a water outlet. The turbine 166 may include a rotor containing one or more magnets (not shown) or made with magnetic material. A wide variety of suitable water flow turbines are commercially available. In use, the turbine 166 with rotor may rotate at a speed that is proportional to the flow rate of water through the water port 125 containing the turbine 166. The sensor 168 may be a reed switch or Hall Effect sensor capable of sensing movement of the magnet(s) in the turbine 166. To facilitate operation of the sensor 168, the turbine 166 may be disposed proximate to the sensor 168. In this embodiment, filter life information can be stored in the filter cartridge RFID chip 162 of replaceable filter cartridge 190. The filter life information may include information regarding the volume of water moved through the filter. In other applications, the electronics module 104 may track additional information, such as the amount of time the filter has been installed or the amount of time that has passed while the system is running. The filter cartridge 190 of this embodiment is provided with an RFID chip 162 (See FIG. 10) that is capable of communicated with an RFID transceiver (not shown) in the electronics modules 104. In use, the electronics module 104 can maintain filter life information in the filter cartridge RFID chip 162. For example, the electronics module 104 can periodically read the filter life information from the filter cartridge RFID chip 162, calculate new filter life information based on use of the WTS 100 (e.g. flow rate and time) and periodically write the new filter life information to the filter cartridge RFID chip 162. In some applications, it may be desirable to minimize the distance between the RFID transceiver (not shown) in the electronics module 104 and the filter cartridge RFID chip 162. In such applications, the filter cartridge RFID chip 162 may be positioned in the upper cylinder 112 to bring it into closer proximity to the RFID transceiver (not shown) in the electronics module 104. Similarly, it may be desirable in some applications to minimize the distance between the sensor 168 and the water flow turbine 166. In such applications, the water flow turbine 166 may be positioned in a water port 125 (e.g. an inlet or outlet) located at the top of the bottom housing assembly 102 immediately below the position of the sensor 168 in the electronics module 104. The features and operation of the electronics module 104 described herein are merely exemplary, and should not be interpreted to limit the scope of the present invention. For purposes of this disclosure, the terms “electronics” and “electronic components” are used to refer to both electronic and electrical components.

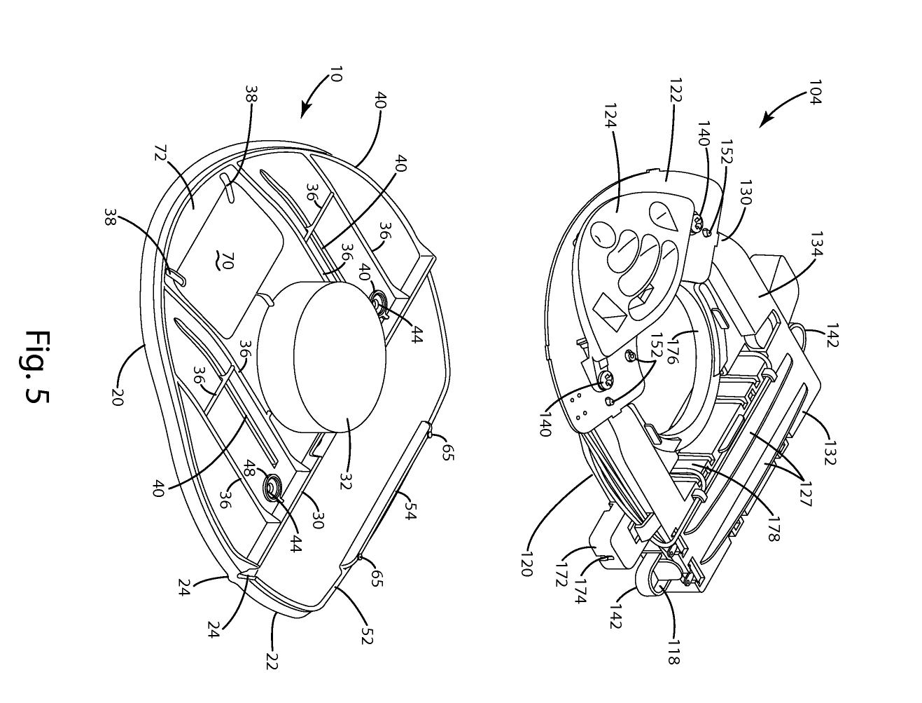

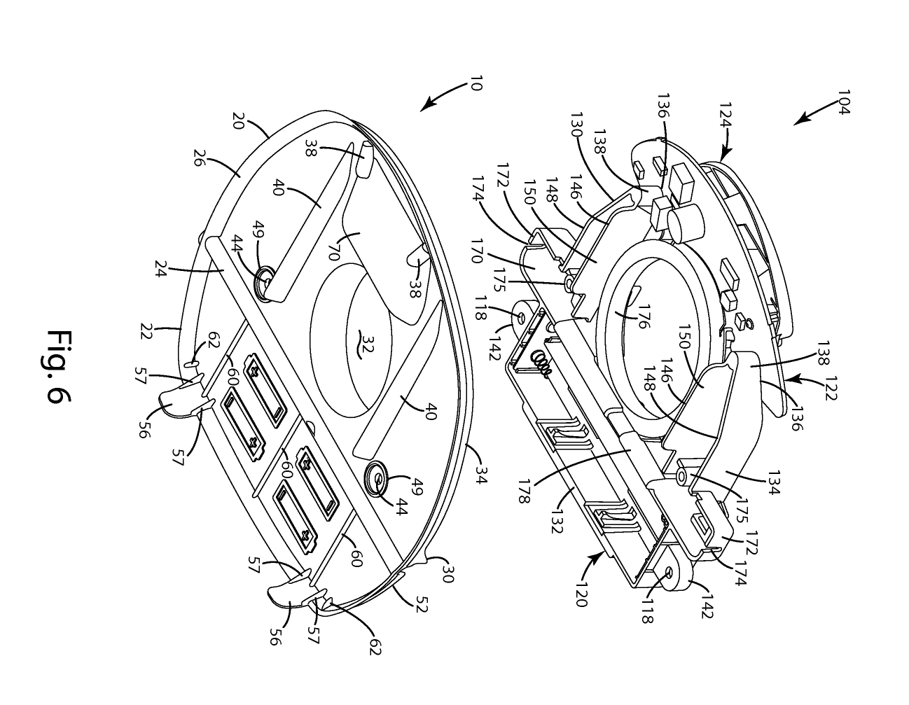

The electronics module 104 of this embodiment generally includes an electronics bracket 120, an electronics assembly 122 and a light guide 124. In this embodiment, the electronics bracket 120 is a structural component that not only supports the electronics assembly 122 and light guide 124, but also provides structural support for the sealing enclosure 10. As perhaps best shown in FIGS. 5 and 6, the electronics bracket 120 is a generally horizontally extending structure having an electronics mounting portion 130, a battery compartment 132 and a bridge portion 134 joining the electronics mounting portion 130 and the battery compartment 132. The electronics mounting portion 130 of this embodiment includes a pair of mounting surfaces 136 that receive the electronics assembly 122 at support it at an angle. Although supporting the electronics assembly 122 at the illustrated angle, the mounting portion 130 may be configured to support the electronics assembly 122 at essentially any desired orientation. The electronics mounting portion 130 may include one or more pins 152 to assist in aligning the electronics assembly 122 on the mounting surfaces 136. The pins 152 may be integrally formed with the electronics bracket 120. For example, the electronics bracket 120 may be injection molded and the pins 152 may be formed during the injection molding process. In this embodiment, the mounting portion 130 also includes a pair of screw bosses 138 for securing the electronics assembly 122 and the light guide 124 to the electronics bracket 120 with screws 140 (See FIG. 5). Sidewalls 146, 148 extend downwardly from the mounting surfaces 136. The inner sidewalls 146 include fins 150 that extend downwardly from the remainder of the electronics bracket 120. As described in more detail below, the bracket fins 150 are interfitted with corresponding slots 40 in the sealing enclosure 10 to retain and lend structural support to the sealing enclosure 10.

The battery compartment 132 is configured to contain the batteries B used for providing power to the WTS 100 (See FIG. 11). The electronics bracket 120 includes four walls that cooperatively form the top and side walls of the battery compartment 132. The battery compartment 132 of this embodiment is a generally rectangular compartment that is sized and shaped to receive four conventional “AA” batteries, but it size, shape and configuration may vary from application to application as desired. As described in more detail below, the bottom of the battery compartment 132 is selectively closed by the sealing enclosure 10. The electronics bracket 120 includes a pair of mounting tabs 142 extending from opposite ends of the battery compartment 132. The mounting tabs 142 define screw holes 118 for mounting the electronics bracket 120 to the top housing 108 with screws 111 (See FIG. 12). The battery compartment 132 of this embodiment also includes a pair of upwardly extending ribs 127 that are configured to engage the undersurface of top wall 114 as perhaps best shown in FIGS. 11 and 12.

As noted above, the bridge portion 134 joins the electronics mounting portion 130 and the battery compartment 132. The bridge portion 134 includes a transverse support channel 170 that accommodates the primary support 30 (described below) extending from the upper surface of the sealing enclosure 10. The transverse support channel 170 extends transversely across the electronics bracket 120 and includes end walls 172 at opposite ends. The end walls 172 define openings (or support holders 174) that closely receive the primary support 30. The support holders 174 retain the primary support 30 to add structural support to the sealing enclosure 10. The bridge portion 134 also defines a central opening 176. The central opening 176 is configured to receive the cylindrical recess 32 (described below) of the sealing enclosure 10. Referring now to FIGS. 5, the bridge portion 134 of this embodiment also defines a well 178 that extends along a portion of the transverse channel 170. The well 178 extends into the space above the living hinge 24 and seats sensor 168 in a location in close proximity to the turbine 166 (See FIG. 11). The size, shape and configuration of the well 178 may vary from application to application as desired. As perhaps best shown in FIG. 6, the bridge portion 134 also includes a pair of downwardly opening screw bosses 175 for securing the sealing enclosure 10 to the undersurface of the electronics bracket 122 with screws 46 (See FIG. 7).

The sealing enclosure 10 of the illustrated embodiment is a one-piece component configured to be fitted into the top housing 108 below the electronics module 104 to close off the bottom of the electronics compartment and the battery compartment and protect them from water infiltration. In this embodiment, the sealing enclosure 10 mounts to the undersurface of the electronics bracket 120. The peripheral edge of the sealing enclosure 10 is directly engaged with the interior surface of the top housing 108 to create a water resistant or leaktight seal there between. As noted above, the sealing enclosure 10 include a stationary portion 20 and movable portion 22 that are joined along a living hinge 24. In this embodiment, the stationary portion 20 covers the electronics compartment 16 and the movable portion 22 covers the battery compartment 132. The living hinge 24 extends across the sealing enclosure 10 from one peripheral edge to the opposite peripheral edge to divide the sealing enclosure 10 into the stationary portion 20 and the movable portion 22. As such, the stationary portion 20 forms a first segment of the perimeter of the sealing enclosure 10 and the movable portion 22 forms a second segment of the perimeter of the sealing enclosure 10. The sealing enclosure 10 includes an integral perimeter seal 26 that extends around the periphery of the sealing enclosure 10 through the stationary portion 20, the movable portion 22 and opposite ends of the living hinge 24. In use, the perimeter seal 26 directly engages the inside of the top housing 108 to provide a water resistant seal between the sealing enclosure 10 and the top housing 108, thereby resisting infiltration of water from the bottom housing assembly 102 into the electronics compartment 16 and the battery compartment 132. In the illustrated embodiment, the perimeter seal 26 is a “wiper-type” seal—meaning that it is shaped somewhat like the blade of a windshield wiper. The perimeter seal 26 of this embodiment is a resilient “skirt” that extends downwardly and outwardly around the entire perimeter of the sealing enclosure 10. In its natural state, the seal 26 extends outwardly beyond the internal dimensions of the inside surface of the top housing 108. As such, there is an interference fit between the perimeter seal 26 and the inside surface of the top housing 108. When the sealing enclosure 10 is fitted up into the top housing, the interference fit causes the perimeter seal 26 to bend downwardly and inwardly following snuggly against the inside surface of the top housing 108. The perimeter seal 26 may taper down toward its bottom end to provide controlled bending of the perimeter seal 26. Although the illustrated perimeter seal 26 is a wiper-type seal, the size, shape and configuration of the perimeter seal 26 may vary from application to application.

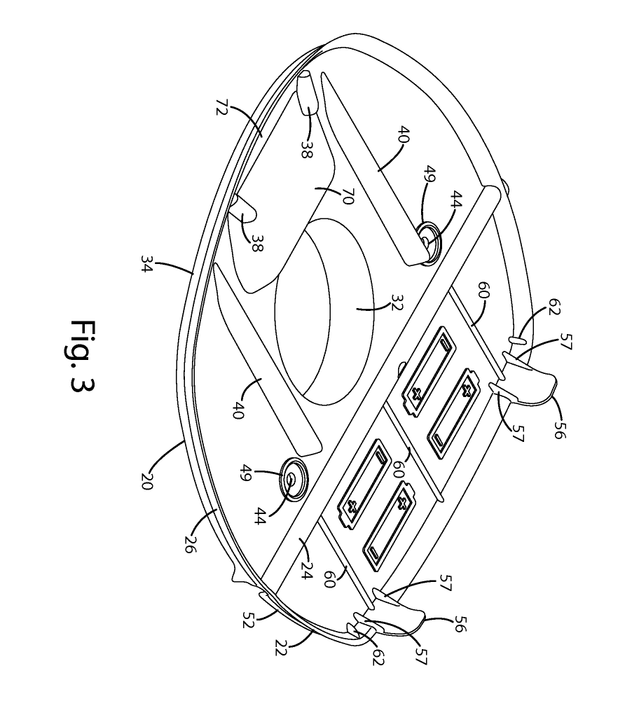

As noted above, the stationary portion 20 covers the electronics compartment 16. The stationary portion 20 of this embodiment is somewhat planar; however, it includes upper recess 70 and angled front 72. The upper recess 70 and angled front 72 are configured to accommodate the above-positioned electronics module 104. The stationary portion 20 includes a plurality of support ribs, including a primary support 30, a peripheral support 34 and a plurality of secondary supports 36. The primary support 30 extends transversely across the sealing enclosure 10 at one edge of the stationary portion adjacent the living hinge 24. The peripheral support 34 extends along the perimeter of the stationary portion 20 inwardly from the perimeter seal 26. The peripheral support 34 may generally be shorter than the primary support 30 and it may end at opposite ends in transition regions that gradually increase in height to merge with the primary support 30. The secondary supports 36 may be arrange along the upper surface of the stationary portion 20 to provide additional support where desired. For example, in the illustrated embodiment, the stationary portion 20 may include four secondary supports 36 that extend generally perpendicularly to the primary support 30 and two that extend generally parallel to the primary support 30. The number, size, shape and configuration of the various support ribs may vary from application to application. The stationary portion 20 may also include a pair of front slots 38 configured to be fitted over the top housing fins 180. The front slots 38 are closed recesses that are shaped to be snuggly interfitted with the housing fins 180. In addition to the front slots 38, the stationary portion 10 may include a pair of primary slots 40 configured to be fitted over the bracket fins 150. The primary slots 40 are closed recesses that extend substantially perpendicularly to the primary support 30. The primary slots 40 are sized and shaped to snuggly receive the bracket fins 150. In use, the top housing fins 180 and the bracket fins 150 help to retain and provide structural support to the sealing enclosure 10. The stationary part 20 also includes a cylindrical recess 32. The cylindrical recess 32 is configured to be fitted over the upper cylinder 112 extending from the bottom housing assembly 102. In this embodiment, the cylindrical recess 32 allows the upper cylinder 112 to extend up into closer alignment with the electronics assembly 122. As noted above, the RFID chip 162 may be mounted in the upper cylinder 112 to provide closer alignment between the RFID chip 162 and the RFID transceiver in the electronics module 104. The stationary part 20 may also include a pair screw holes 44 for mounting the sealing enclosure 10 to the electronics bracket 120 with screws 46. Each screw hole 44 may be surrounded by a circular support rib 48. The circular support ribs 48 may be joined to the primary support 30 by support segments 50. In addition to the circular support ribs 48 on the upper surface of the stationary portion 20, each screw hole 44 may also be surrounded by a circular support rib 49 on the undersurface of the stationary portion 20 as shown, for example, in FIG. 3.

The movable portion 22 covers the battery compartment 132, but is selectively movable to allow access to the battery compartment 132. The movable portion 22 is generally planar and generally includes support ribs, a catch 54 and a pair of pull tabs 56. The support ribs may include a peripheral support 52 extending upwardly along the perimeter of the movable portion 22 inwardly from the perimeter seal 26. The peripheral support 52 of the movable portion 22 may be a complement to the peripheral support 34 of the stationary portion 20. The support ribs may also include a plurality of support ribs extending downwardly from the undersurface of the movable portion 22. The downwardly extending support ribs may include cross supports 60 and corner supports 62. The catch 54 extends upwardly from the movable portion 22 to fit into the space between the outer edge of the electronics bracket 120 adjacent the battery compartment 132 and the inside surface of the top housing 108 (See FIG. 11). The catch 54 may include supports 65 and be joined to peripheral support 52 by support segments 64. In use, the catch 54 engages the outer edge of the electronics bracket 120 to help hold the movable portion 22 in the closed position. The size, shape and configured of the catch 54, including its supports, may vary from application to application to, among other things, control the amount of force required to open and close the movable portion 22. For example, the catch 54 may be provided with a lip or other contours that interfit with the electronics bracket 120. In the illustrated embodiment, the movable portion 22 includes two tabs 56. The pull tabs 56 of this embodiment are extensions of the perimeter seal 26. The pull tabs 56 may include bumps 58 that engage inside surface of the top housing 108 to hold pull tabs 56 out away from the top housing 108 so that they can be easily grasped by a user. The number, size, shape and configuration of the pull tabs 56 may vary from application to application. Each of the pull tabs 56 may include a pair of support ribs 57. If desired, the undersurface of the movable portion 22 may include graphics to indicate that it covers the battery compartment 132. For example, in the illustrated embodiment, the undersurface of the movable portion 22 is provided with representations of batteries. The representations may not only indicate that batteries are accessible beneath the movable portion 22, but also show the direction in which the batteries are to be installed.

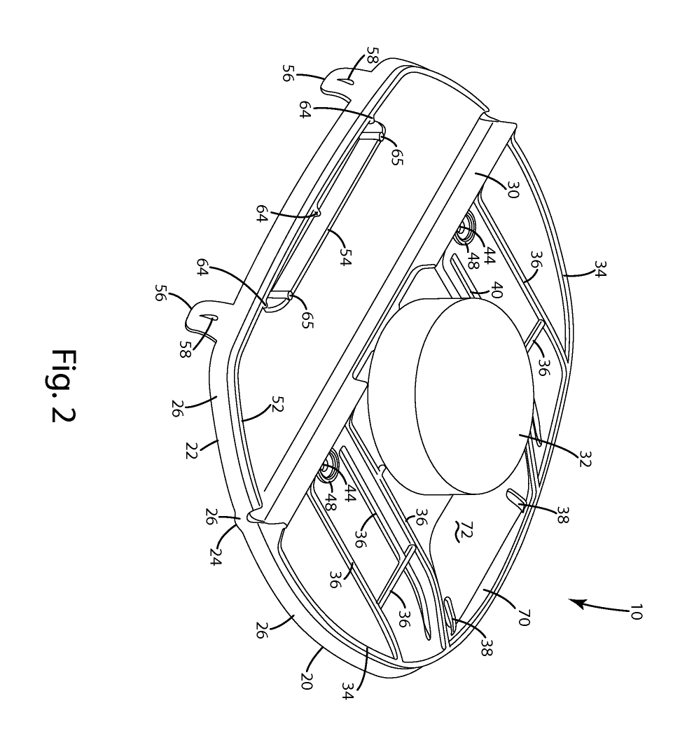

The movable portion 22 is joined to the stationary portion 20 by living hinge 24 so that the movable portion 22 can be easily moved between open and closed positions (compare FIGS. 7 and 8). In this embodiment, the living hinge 24 is formed by a semicircular portion of material. Referring now to FIG. 11, the living hinge 24 may correspond in shape with the undersurface of well 178. As shown in FIGS. 1 and 2, the perimeter seal 26 may extend along opposite ends of the living hinge 24 so that the perimeter seal 26 is continuous around the entire perimeter of the sealing enclosure 10. The size, shape and configuration of the living hinge 24 may vary from application to application as desired. For example, the living hinge may be a square hinge, a triangular or other shape that varies from the plane of the stationary portion 20 and the movable portion 22. As another example, the living hinge 24 may be a generally planar continuation of the stationary portion 20 and the movable portion 22. In this planar alternative, the living hinge 24 may be a portion of material that is made flexible by the absence of support ribs or by reducing the thickness of the material in the region of the living hinge 24.

In the illustrated embodiment, the sealing enclosure 10 is manufactured from a relatively soft material that facilitates formation of a leaktight seal between the perimeter seal 26 of the sealing enclosure 10 and the top housing 108. It is generally desirable for the sealing enclosure 10 to be soft enough for the perimeter seal 26 to be flexible and to form a water resistant seal with the top housing 108. At the same time, it is generally desirable for the sealing enclosure 10 to be hard enough to have sufficient structural integrity to function properly. For example, the sealing enclosure 10 material should he hard enough to firmly interfit with the top housing 108 and to handle the load of the mounting screws. The sealing enclosure 10 of the illustrated embodiment is injection molded from a thermoplastic elastomer (“TPE”). The material may have a durometer hardness in the range of about 60 Shore A to about 90 Shore A. In typical applications, it may be desirable for the material to have a durometer hardness in the range of about 70 Shore A to about 80 Shore A. In the illustrated embodiment, the material is a TPE having a durometer hardness of about 75 Shore A.

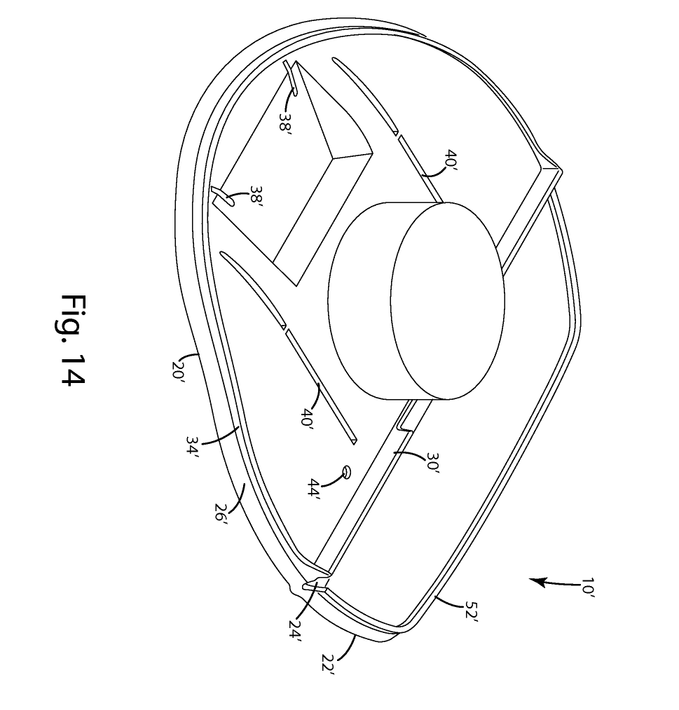

An alternative embodiment of the present invention is shown in FIG. 14. In this embodiment, the sealing enclosure 10′ is formed from two different materials of different hardness. For example, the perimeter seal 26′ and the living hinge 24′ may be manufactured from a soft material while the remainder of the sealing enclosure 10′ is formed from a harder material. In this embodiment the stationary portion 20′ and the movable portion 22′ may be formed separately from one another and may be joined by a softer material using an overmolding process. In one embodiment, the stationary portion 20′ and the movable portion 22′ are injection molded using a TPE or other suitable elastomeric material with a relatively high hardness, for example, a durometer hardness of about 80 Shore A or greater. With the use of a harder material, the stationary portion 20′ and movable portion 22′ of this embodiment do not include many of the support ribs included in the embodiment of FIGS. 1-13. For example, in this alternative embodiment, the sealing enclosure includes primary support 30′ and perimeter supports 34′ and 52′. The other support ribs are not included, such as those surrounding the screw holes 44′. If desired, sealing enclosure 10′ may include closed slots 38′ and 40′. After injection molding, the stationary portion 20′ and the movable portion 22′ may be placed in a second mold and the perimeter seal 26′ and living hinge 24′ may be formed directly onto the stationary portion 20′ and movable portion 22′ using a TPE or other suitable material that is softer than the material of the stationary portion 20′ and the movable portion 22′. For example, the material used to form the perimeter seal 26′ and the living hinge 24′ may have a durometer hardness of about 75 Shore A or less. As an alternative to using a separate mold for forming the perimeter seal 26′ and the living hinge 24′, the sealing enclosure 10′ may be formed in a dual-shot mold. For example, the same mold can be used to form the stationary portion 20′ and movable portion 22′ in a first shot and the perimeter seal 26′ and living hinge 24′ in a second shot of softer material. In this example, the mold is reconfigurable after the first shot to create space around the stationary portion 20′ and the movable portion 22′ in the shape of the living hinge 24′ and perimeter seal 26′. So, a second shot of material can be injected into the newly created space to form the perimeter seal 26′ and living hinge 24′ directly onto the stationary portion 20′ and the movable portion 22′. Although not shown, the peripheral edges of the stationary portion 20′ and movable portion 22′ may be shaped to facilitate an improved connection with the perimeter seal 26′ and living hinge 24′. For example, the peripheral edges of the stationary portion 20′ and movable portion 22′ may include a head (not shown). The portion of the sealing enclosure 10′ formed of softer material may vary from application. For example, in the illustrated embodiment, the primary support 30′ and peripheral support 34′ and 52′ are formed of harder material with the stationary portion 20′ and the movable portion 22′. If desired, the primary support 30′, peripheral support 34′ and/or peripheral support 52′ may be formed of a softer material with the perimeter seal 26′ and living hinge 24′. As another example, the living hinge 24′ may be formed of harder material with the stationary portion 20′ and the movable portion 22′. In this alternative example, only the perimeter seal 26′ is formed of softer material.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A water treatment system comprising:
a housing having an interior surface defining an interior region;
an electronics module mounted within said interior region of said housing, said electronics module having an accessible compartment;
a water treatment assembly mounted within said interior region of said housing; and
a sealing enclosure mounted within said interior region of said housing to separate said electronics module from said water treatment assembly, said sealing enclosure being of one-piece and having a stationary portion and a movable portion separated by a living hinge, said movable portion being aligned with said accessible compartment and being selectively movable to provide selective access to said accessible compartment, said sealing enclosure having a peripheral edge in direct engagement with said interior surface of said housing, said peripheral edge of said sealing and said interior surface of said housing interacting to define a water resistant seal therebetween.

2. The system of claim 1 wherein said living hinge extends entirely across said sealing enclosure such that said peripheral edge is cooperatively defined by a portion of said stationary portion and a portion of said movable portion.

3. The system of claim 2 wherein said sealing enclosure is manufactured from a thermoplastic elastomer having a durometer hardness of between about 70 Shore A and 80 Shore A.

4. The system of claim 2 wherein said sealing enclosure is manufactured from a thermoplastic elastomer having a durometer of about 75 Shore A.

5. The system of claim 3 wherein said electronics module includes a bracket supporting electronic components, said sealing enclosure being mounted to an undersurface of said bracket.

6. The system of claim 5 wherein said bracket includes at least one fin and said sealing enclosure includes at least one closed slot, said fin being closely fitted within said closed slot.

7. The system of claim 5 wherein said bracket includes at least two fins extending generally perpendicularly to a longitudinal extent of said living hinge, said sealing enclosure including at least two closed slots, each of said fins being uniquely fitted into a corresponding one of said closed slots.

8. The system of claim 5 wherein said water treatment assembly includes a water flow turbine and said electronics module includes a turbine sensor, said bracket including a well extending into said living hinge, said turbine sensor being disposed in said well.

9. The system of claim 1 wherein said perimeter seal is a wiper-type seal extending continuously around the perimeter of the sealing enclosure extending outwardly and at an angle to the direction in which said sealing enclosure is inserted into said interior region, whereby said perimeter seal is interference fit with said interior surface of said housing.

10. The system of claim 9 wherein said movable portion includes at least one pull tab to assist in opening said movable portion, said pull tab being an extension of said perimeter seal.

11. The system of claim 9 wherein said movable portion includes at least two pull tab to assist in opening said movable portion, each of said pull tabs being an extension of said perimeter seal.

12. The system of claim 11 wherein each of said pull tabs includes a bump extending toward said interior surface of said housing, said bumps holding said pull tabs away from said interior surface where said pull tabs are readily accessible.

13. The system of claim 1 wherein said housing includes a top housing and a bottom housing, said electronic components and said sealing enclosure mounted in said top housing, said water treatment assembly being mounted in said bottom housing, said top housing having a top wall and a skirt extending downwardly from said top wall, said top wall and said skirt cooperatively defining an upper portion of said interior space, said electronic components being mounted in said upper portion of said interior space, said sealing enclosure being mounted in said upper portion of said interior space beneath said electronic components, whereby said sealing enclosure encloses said electronic components in said upper portion of said interior space.

14. The system of claim 1 wherein said sealing enclosure is formed of two different materials, at least one of said stationary portion and said movable portion being primarily formed from a first material, said living hinge and said perimeter seal being formed from a second material softer than said first material.

15. A water treatment system comprising:
a bottom housing assembly having a bottom housing defining a lower interior space and a water treatment assembly mounted in said lower interior space;
a top housing fitted onto said bottom housing assembly, said top housing defining an upper interior space above said water treatment assembly;
an electronics module mounted in said upper interior space, said electronics module having an electronics compartment and an accessible compartment;
a sealing enclosure mounted in said upper interior space beneath said electronics module and above said water treatment assembly, said sealing enclosure having a stationary portion disposed beneath said electronics compartment and a movable portion disposed beneath said accessible compartment, said movable portion being joined to said stationary portion by a living hinge, said living hinge extending entirely across said sealing enclosure such that a peripheral edge of said sealing enclosure is cooperatively defined by said stationary portion and said movable portion, said sealing enclosure being of one piece and having a perimeter seal in direct engagement with said top housing, said perimeter sealing being continuous and extending entirely around said peripheral edge of said sealing enclosure to provide a water resistant seal around said sealing enclosure, said perimeter seal having a first portion extending along said movable portion, said movable portion being pivotally movable about said living hinge between an open position in which said first portion of said perimeter seal is at least partially disengaged from said top housing to provide access to said accessible compartment and a closed position in which said first portion of said perimeter seal is engaged with said top housing to form a complete seal about said sealing enclosure.

16. The system of claim 15 wherein said sealing enclosure is manufactured from a thermoplastic elastomer having a durometer hardness of between about 70 Shore A and 80 Shore A.

17. The system of claim 15 wherein said sealing enclosure is manufactured from a thermoplastic elastomer having a durometer of about 75 Shore A.

18. The system of claim 15 wherein said sealing enclosure is formed of two different materials, at least one of said stationary portion and said movable portion being primarily formed from a first material, said living hinge and said perimeter seal being formed from a second material softer than said first material, said second material being overmolded onto said first material.

19. The system of claim 15 wherein said electronics module includes a bracket supporting electronic components, said sealing enclosure being mounted to an undersurface of said bracket.

20. The system of claim 19 wherein said stationary portion includes a primary support extending along said living hinge to provide structural support, said primary support being interfitted with a support holder in said bracket.

21. The system of claim 20 wherein said bracket includes a support fin and said stationary portion includes a closed slot fitted over said bracket fin.

22. The system of claim 21 wherein said top housing includes a support fin and said stationary portion includes a closed slot fitted over said top housing fin.

23. The system of claim 22 wherein said bracket includes a well extending into said living hinge, said electronic components including a sensor disposed in said well.

24. The system of claim 23 wherein said accessible compartment is a battery compartment.

25. A sealing enclosure for a water treatment system having a housing containing a water treatment assembly, an electronics compartment and an accessible compartment comprising:
a stationary portion configured to be disposed between the electronics compartment and the water treatment assembly;
a movable portion configured to be disposed between the accessible compartment and the water treatment assembly, said movable portion being joined to said stationary portion by a living hinge, said living hinge extending entirely across said sealing enclosure such that a peripheral edge of said sealing enclosure is cooperatively defined by said stationary portion and said movable portion, said sealing enclosure having a perimeter seal configured to be in direct engagement with the housing of the water treatment system, said perimeter sealing being continuous and extending entirely around said peripheral edge of said sealing enclosure, whereby said perimeter seal is capable of providing a water resistant seal between said sealing enclosure and the housing entirely around said sealing enclosure, said movable portion being configured to be pivotally movable about said living hinge between an open position to provide access to the accessible compartment and a closed position to close the accessible compartment and form a complete seal about said sealing enclosure.
